(19) United States
(12) Patent Application Publication
(10) Pub. No.: US 2006/0112056 A1
(43) Pub. Date: May 25, 2006

(54) Problem solving graphical toolbar

(75) Inventors: Andrea P. Sullivan, Chicago, IL (US); Hope Rubin - Haiman, Wayne, NJ (US)

Correspondence Address: ACCENTURE, LLP;C/O HOGAN & HARTSON, LLP (IPGROUP), 555 13TH STREET NW, SUITE 600E, WASHINGTON, DC, 20004, US

(73) Assignee: Accenture Global Services GmbH

(21) Appl. No.: 10/949,873

(22) Filed: Sep. 27, 2004

(51) Int. Cl. G06N 5/02

(52) U.S. Cl. 706/47

(57) ABSTRACT

The present invention provide a graphical application for guiding a user through an end-to-end process for addressing a problem. The graphical application prompts users to define the problem in a logical, consistent way. Once the problem in defined, the application further directs the users through a systematic processing for solving the problem, including structuring ideas for addressing the problem, investigating the problem, generating findings on the ideas, and generating further additional ideas in response to the generated findings on the existing ideas. The structuring of the ideas may be done through the creation of an issue tree, and the investigation of the problem may be structured through a research plan. Once a solution developed, the invention may further guide users in the presentation of the proposed solution, including the creation of a message plan, a process pyramid, and/or a story board depicting the solution.

### CROSS REFERENCE TO RELATED APPLICATIONS

Not Applicable.

### STATEMENT REGARDING SPONSORED RESEARCH OR DEVELOPMENT

Not Applicable.

### REFERENCE TO SEQUENCE LISTING

Not Applicable.

### BACKGROUND OF THE INVENTION

1. Field of the Invention

Embodiments of the present invention relate to a system and method for graphically guiding a user through a systematic process for defining a problem, systematically solving that problem and communicating a solution to that problem.

2. Discussion of Relevant Prior Art

Numerous known automated tools are available to assist to a user to systematically address various problems. For instance, several commercially available applications allow users to define a problem. Other applications allow users to research and/or solve the defined problems. Still other applications assist users in presenting visually solutions. However, there is no known technology that will easily guide a user through the process of defining and solving, and then presenting the solution. Consequently, users currently export information between several, potentially incompatible applications. This cause excess work for the user as well as discourage problem solving. For example, a user may define and solve a problem, but then never present a solution, thereby wasting the user's efforts. By providing an end-to-end solution, organizations can better track

### BRIEF SUMMARY OF THE INVENTION

In response to these and other needs, embodiments of the present invention provide a graphical application for guiding a user through an end-to-end process for addressing a problem. The graphical application prompts users to define the problem in a logical, consistent way. Once the problem in defined, the application further directs the users through a systematic processing for solving the problem, including structuring ideas for addressing the problem, investigating the problem, generating findings on the ideas, and generating further additional ideas in response to the generated findings on the existing ideas. The structuring of the ideas may be done through the creation of an issue tree, and the investigation of the problem may be structured through a research plan. Once a solution developed, embodiments of the present invention may further guide users in the presentation of the proposed solution, including the creation of a message plan, a process pyramid, and/or a story board depicting the solution.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIGS. 1-4 and 5A-5C depicts screen shots from a problem solving toolbar in accordance with embodiments of the present invention.

### DETAILED DESCRIPTION OF THE DRAWINGS

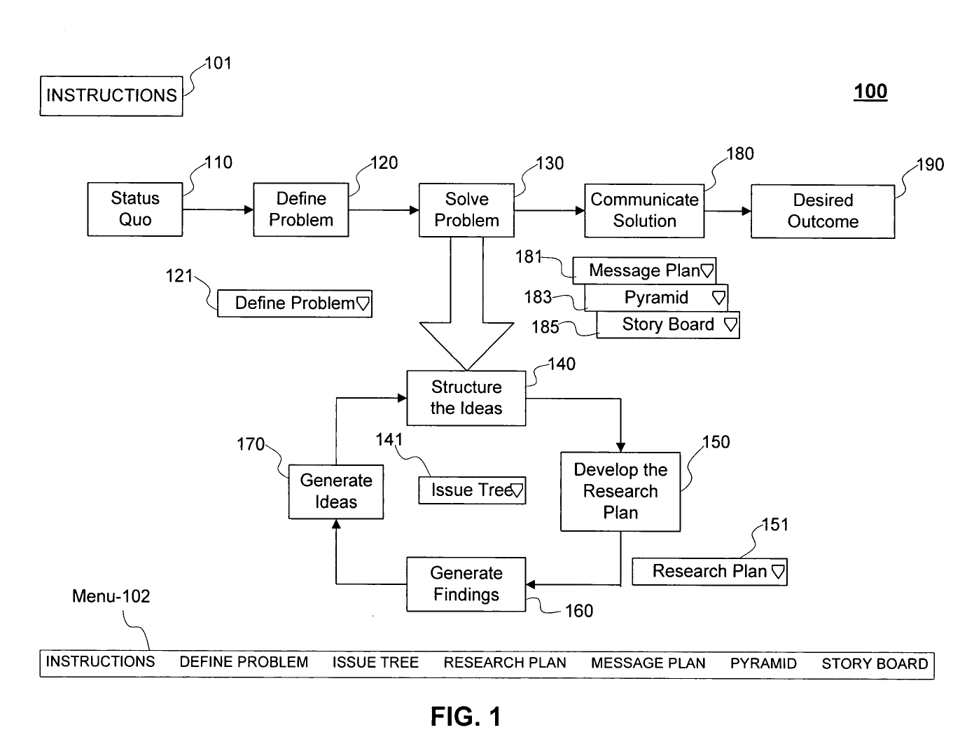

Embodiments of the present invention provide a software-based tool for guiding a user through a systematic process for generally defining, analyzing, and solving a problem. Turning now to FIG. 1, a graphical problem-solving tool 100 is depicted. The 100 contains various components that systematically direct a user through a problem solving process, and these graphical components are described in greater detail below. The present invention has particular application to the providing of goods and services customer, through the defining of: (a) goods and services to be providing; and (b) a plan for providing the goods and services specified in (a). The problem-solving tool 100 may include a instruction button that a user may select in order to receive guidance on the various features and aspects of the problem-solving tool 100. Similarly, the problem-solving tool 100 may include a menu bar 102 that allows the user to directly access the various features and aspects of the problem-solving tool 100.

The problem-solving tool 100 starts at a start position 110 that represents the status quo to be adjusted by the problem-solving tool 100. In a business context, the start position 110 embodies the current situation, including the business issues that are compelling change to the current situation. For instance, the start position 110 may represent a market and a business's position in that market. In the same way, a desired outcome 190 of the problem-solving tool 100 represents the desired result from the problem solving. Typically, the desired outcome 190 reflects the changes in the status quo 110 that the user desires to produce.

Continuing with the problem-solving tool 100, the conditions at the start position 110, along with the problem to be addressed, are defined by the user through a problem definition module 120. The problem definition module 120 allows the user to clearly and succinctly define key facts about the current situation in the start position 110, the business issue or complication which is compelling change, and the key questions to be addressed to deal with the business issue or complication. For example, the problem definition module 120 may prompts a user for various data as needed to define current conditions. In a preferred implementation, a user may access the problem definition module 120 though a problem definition button 121. In particular, a user's selection of the problem definition button 121 causes a problem definition drop-down menu 122 to appear.

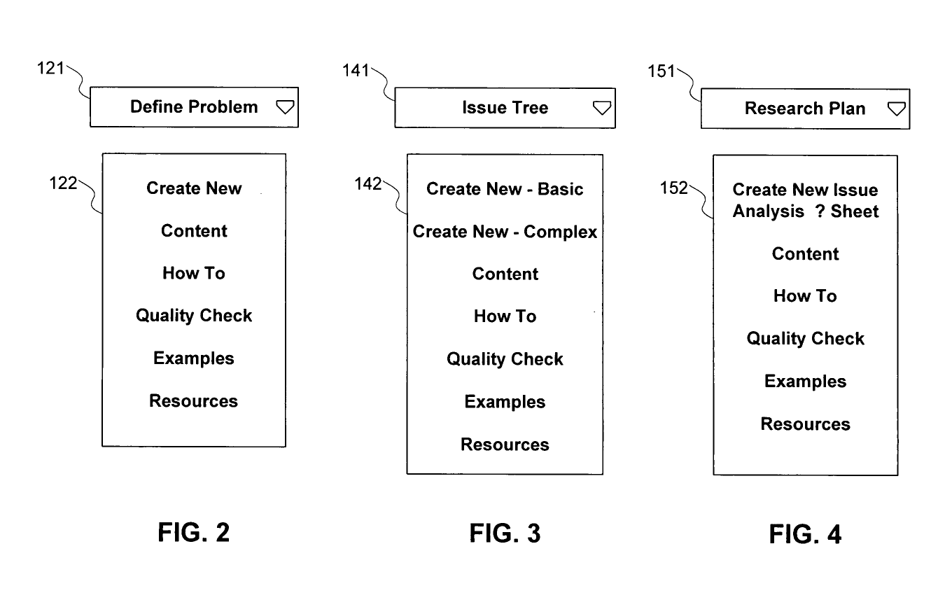

The problem definition drop-down menu 122 is depicted in FIG. 2 and automatically guides a user to through a process for submitting data to define the problem to be solved. The problem definition drop-down menu 122 is subdivided into multiple possible entries, and a user may select various combinations of these entries as needed to define the problem to be solved. Referring back to FIG. 2, the problem definition drop-down menu 122 may include a Create New option to initiate the creation of a new Problem Definition Worksheet (PDW). For example, the Create New option may be a sub-application created in Visual Basic or other programming language to open an input screen with various fields as needed to define the problem. Alternatively, the sub-application associated with the Create New option may cause a document form to open in a application with text-editing capability, such as Word®, Excel® or Powerpoint®, all marketed by Microsoft, Inc. of Redland Wash.

The Problem Definition Worksheet (PDW) is a relatively short document, approximately one-page, that captures essential information about the project. Most of this information should be defined before the arrangement letter is written and can often be found there. A completed PDW is a strong communication tool to help all team members understand and agree on what the project is about. The PDW captures key contextual considerations of an engagement, which are:

Client Context-What is the client's situation, complication, or business issue compelling change, the desired outcome of the project, and the key question for the project to address?

Buyer Context-Who is sponsoring the project, who makes decisions, and what quality standards are expected?

Scope Context-What is included in and excluded from the project?

Why is accurate problem definition critical?

If the key question is ill-defined or inaccurate, the team will likely waste time on irrelevant research and analysis that the client does not want.

To complete a problem definition worksheet, the user first must gain an understanding of the context. Specifically, the user first identifies the situation. For example, user identifies the key, non-controversial facts about the client's situation. The user may need to obtain facts through research of the company and industry, and by asking relevant experts. The user then identifies the Complication to solving the problem. For example, the user identifies the “burning platform” or the reason why the client needs to change; the industry or competitive dynamics forcing the client to respond; the reasons the client is interested in pursuing a new market or product line; and the causes forcing potential outcomes that the client wishes to avoid.

At this point, the client next define the key question, in light of the Situation and Complication. Specifically, the user designates the key, strategic question the project should address. It is often difficult to formulate a key question that everyone will agree to, but it is the only way to make sure that:
Clients understand the project they are buying;
All team members are working on the same project, that is, they are actually working to answer the same question.

In most business situations, the user should further have a clear understanding of who are the client sponsors (i.e., sponsors are typically the clients the user works with most directly, as well as the people to whom they report), as well as who has decision-making authority that can directly impact the outcome of project. For all of these people, the user defining the problem should consider how their goals, personalities, and vested interests might affect the project. The user's team should also understand their expectations for quality, status reporting, deliverables, etc.

Continuing with the problem definition through the problem definition module 120, the user next defines the desired outcomes of the project. This is generally a simple statement that describes what everyone expects by the end of the project. Tangible deliverables (such as reduced budget costs) are generally included, and less tangible deliverables may also be included if they are expected, such as consensus among team members.

The user next identifies the scope of the problem, because it is often very important to document what the client and user agrees are “In Scope” areas for the project, versus “Out of Scope” areas. Misunderstandings and “Scope Creep” can cause the user to spend many late-night hours researching and analyzing areas are not part of the project. For example, In Scope areas might include a competitive assessment and a branding strategy, while “Out of Scope” might be an operational impact assessment.

To assist the user in the creation module, the problem definition module 120 may provide definitions of the different portions of the PDW through the Content option of the problem definition drop-down menu 122. Similarly, the “how to” option of the problem definition drop-down menu 122 may provide instructions regarding completing the sections of the PDW. The “examples” option of the problem definition drop-down menu 122 may provide examples of completed sections of the PDW in order to guide the user through creation process.

Upon completion of the PDW, the user next selects the Quality Check option of the problem definition drop-down menu 122 to ensure completeness and accuracy of the PDW. The problem definition module 120 then walks the user through a series of questions addressing the completeness and accuracy of the PDW. For example, the problem definition module 120 may present the user with the following series of questions:

1. Has the User Gained an Understanding of the Context?

Situation:
Does everyone agree to the key facts in the situation?
Do the key facts describe the most important elements of the situation?

Complication:
Does the complication point to why the client needs to change urgently?
Are the complications the most critical reasons a client should change right now as opposed to waiting?

Key Question:
Does the key question capture the core problem to be addressed?
Do client and the user's team members agree that this is the core problem at hand?
Can the question be further broken down by “How” or “Why” questions?
Is the question focused, not open-ended or multi-faceted?
Is the language clear; does everyone agree on the meaning of the words chosen?

2. Has the User Identified Buyers and Expectations?

Sponsors
Are these the most important clients for the user's team?

Key decision makers
Do these individuals have authority to sign an arrangement letter, approve the deliverables, etc.?
Has the User included the names of individuals to whom the client sponsors are accountable for the results of this project?

Criteria for quality
Have these points been expressed directly by the client?
Are there any implicit criteria that have been mentioned in more casual conversations with the client?

3. Has the User Identified the Scope?

Desired Outcomes of the Project
Would the client be fully satisfied if the team delivered these items?
Is it possible to achieve these outcomes given the key question and scope of the effort?

In scope
Has the User included all of the major areas of focus for the assignment?
Has the User included areas that the client expressly wants to include?
Are all interim and final deliverables listed, with target dates?
Do all client and the user's team members agree to this list?

Out of scope
Has the User included all areas most likely to lead to “scope creep”?
Has the User included areas that the client expressly wants to avoid?

Returning now to FIG. 2., the “resources” option of the problem definition drop-down menu 122 further allows a user to connect to relevant resources to gain additional information as needed to define the problem. For example, the problem definition module 120 may connect the user to product descriptions so that the user may learn more about commercially available solutions. Similarly, the problem definition module 120 may connect the user to Skills Assessment that tests the users skills in the available solutions and to Learning Resources that identify self-study, virtual and live training opportunities to improve the user's skills in the commercially available solutions. The problem definition module 120 may further provide a Communications Home Page that finds experts for help with client deliverables, on-the-job coaching and more.

Returning to FIG. 1, the user next seeks to develop a solution through a problem solving module 130 for the problem defined through problem solving module 120. The problem solving module 130 generally include several sub-modules 140, 150, 160, and 170 that recursively guide the user to a solution. The first step in finding a solution a idea structuring module 140, that the user accesses through an issue tree button 141 that presents the user with an issue tree menu 142, as depicted in FIG. 3.

The idea structuring module 140 guides the user through a processes to define an issue tree addressing the problems defined in the problem definition module 120 (such as the above described PDW). An issue tree breaks down the Key Question into smaller, logical components. These components or issues are then further broken down into sub-issues, which are broken down into sub-sub-issues, and so on. The user continues until producing a list of discrete questions that can be more easily answered with research and analysis. Each level of the Issue Tree should be at the same level of abstraction and should be MECE, that is, Mutually Exclusive/Collectively Exhaustive. “Mutually Exclusive” means that no redundancy should exist among sub-issues on the same level. “Collectively Exhaustive” means that all the sub-issues on one level should “add up” to the universe of possibilities represented by the group of issues on the level to the left. For instance, in discussing emerging economics in Asia-Pacific, some issues may be “Thailand”, “Hong Kong”, or “Singapore”. If the user included “Eastern Hemisphere,” the user would be mixing levels of abstraction. If the user fails to include Malaysia, the user would not be collectively exhaustive.

Issue Trees help the user structure her thinking and both improve communication and focus the efforts of the team. Issue Trees challenge the user to decompose the key question in a logical and rigorous manner so that the user can be confident that she have explored the universe of possibilities. Since Issue Trees help the user group and organize the generated ideas, the user can more easily review her thinking with others. Meanwhile, with this “complete list” of issues, the user can confidently proceed with research and analysis efforts and avoid any research or analysis that is not directly related to the question at hand.

The issue tree produced by the problem structuring module may be Hypothesis-driven or Data-driven Issue Trees. A hypothesis-driven tree begins with a desired end point or potential solution and the tree focuses on “how” the user can achieve it. Consequently, the branches of the tree are hypothesized actions the user can follow to achieve the solution. The team might, for example, begin with a question as follows: “How can the hospital improve profitability?” The branches of the tree answer “How?” that is, by targeting a certain high-potential customer segment, by improving inventory management, etc. Research and analysis would then focus on testing-confirming or refuting-these hypotheses. Because hypothesis-driven trees require strong insight into the problem, it is better suited for people with strong content knowledge.

For people who do not have deep content expertise, data-driven trees are often easier to use. Data-driven trees start with a “why?” key question and the subsequent tree branches provide reasons. For example, the key question “Why is the hospital profitability declining?” can be broken down into “because operating costs are increasing” and “because revenues are declining”—both of which suggest answers to “why?”

To begin creating an Issue Tree through the idea structuring module 140, the user selects an issue tree template from issue tree menu 142. The issue tree menu 142 may contain several templates, such as basic and complex templates, that user may select according to the nature of the problem to be addressed. The user may then fill in the selected template.

At first, the user will usually brainstorm if necessary. If the user are unfamiliar with the issue at hand, the user should brainstorm ideas about potential answers to the key questions to help the user get started. Once the user has generated a wide-ranging list of ideas, the user begins grouping them into logical categories and organizing them by level of abstraction or granularity.

Once ideas are identified, the user maps the ideas to the issue tree template. Looking at the groups of ideas, the user identifies the ones that seem to be at the highest level and most directly related to the key question. In this way, the user verifies that the key question is the right one. The user maps the largest issues as the first level to the right of the key question. The user should make sure that the first level is MECE, that is, there is no redundancy among sub-issues on the same level and all of the sub-issues on this level “add up” to the universe of possibilities.

The user next expand the issues by breaking down each issue into its sub-issues, always making sure to be MECE. The user continues until the link between the issues on the tree and the research and analysis required becomes clear. The building an Issue Tree is an iterative process, and the user will often discover that MECE becomes increasingly difficult with additional branches. Consequently, the user may need to rethink earlier branches-or even the original question as the user works out the structure. The iteration is expected and normal, and is part of the rigor and logic of the process.

In creating strong Issue Trees, the user should try to explore alternative ways to decompose the problem because every problem can often be mapped in multiple ways. Thus, the user should look for other ways to consider including additional components (e.g., steps in process), key success factors, benefits, and risks. As suggested above, the user should test that every level is MECE and should recognize that the process is often iterative.

At times, it is possible that issues do not fit on an Issue Tree. It is acceptable to have issues that do not fit on the user's Issue Tree. If this happens, the user moves those issues off to the side. The user does not discard them entirely, but merely addresses them later. Some issues may be out of scope or immaterial. If so, the user flags them as such. Other “orphan” issues may indicate either that the user have missed a tree branch, that the user has a poorly constructed group of issues, or that the user has inaccurately defined the key question.

Thus, problems developing an Issue Tree through the idea structuring module include the formation of issue trees that:
1. Are too simple or generic and do not relate specifically to the client's situation
2. Use unclear language, often indicative of unclear logic
3. Have the same issues on multiple branches
4. Include a laundry list of issues that need to be grouped to a higher level
5. Provide analytical or prescriptive answers instead of breaking down the problem
6. Do not answer the ‘How’ or ‘Why’ question

In checking over the produced issue tree, the user should insure that the Issue Tree is MECE. Other common errors include omitting logical possibilities and/or mixing problems and potential solutions; placing details of lower-level branches at a higher level and not summarizing to a higher-level grouping; and providing analysis instead of breaking down the problem.

To assist the user in the creation module, the issue structuring module 140 may provide definitions of the different portions of the issue tree through the Content option of the issue tree drop-down menu 142. Similarly, the “how to” option of the issue tree drop-down menu 142 may provide instructions regarding completing the sections of the issue tree. The “examples” option of the issue tree -down menu 142 may provide examples of completed sections of the issue tree in order to guide the user through creation process.

Upon completion of the issue tree, the user next selects the Quality Check option of the issue tree drop-down menu 142 to ensure completeness and accuracy of the issue tree. The issue tree module 140 then walks the user through a series of questions addressing the completeness and accuracy of the issue tree. For example, the issue tree module 140 may present the user with the following series of questions:

Is the Issue Tree Insightful?

Does the Issue Tree:
Account for the specificity of the situation?
Break down the problem enough so that the user can envision what analyses are required?
Have only 3-5 branches at any one intersection? If the user has a laundry list, the user probably has not identified a useful higher-level grouping.
Use a structure that helps the team think about the problem in a different or more complete way?
Do the issues identified consistently answer “How?” or “Why?” as the user moves through the issue tree?

To address the issues addressed in the issue tree created by the issue tree module 140, the uses next forms a research plan using a research plan module 150, that the user accesses through a research plan button 151 that presents the user with a research plan menu 152, as depicted in FIG. 4.

The research plan, consisting of an Issue Analysis Worksheet and a Work Plan, enables the user to quickly begin answering the questions or proving/disproving the hypotheses generated in the Issue Tree. It requires the user to think through the types of analyses the user will have to perform, the data required, and potential sources for that data. It also allows the user to organize the research and analysis effort in the most efficient way possible.

To create a research plan, the user first defines hypotheses to be addressed. If the user has created a data-driven tree, the user starts forming the research plan by forming hypotheses that answer the end (most specific) issues of the tree. If the user developed a hypothesis-driven issue tree, the user can use the end issues as hypotheses and add additional, more specific hypotheses as necessary. Once the user has a set of specific hypotheses, the user begins by considering what analysis or rationale will be required to prove or disprove each hypothesis satisfactorily. Next, the user should identify what kinds of data the user will need to perform the analyses and potential sources of the data. After all of the research and analysis elements have been identified, the user should group the required research and analysis into workstreams and identify people responsible for the research and timeframes for performing the research.

There are two components to the Research Plan: the Issue Analysis Worksheet and the Workplan. The Issue Analysis Worksheet includes four major elements:
1. Issues: Restate the issues from the far right side of the Issue Tree.
2. Hypotheses: the user's hypotheses are the “Best Guess” as to the answer to the underlying question. There should be numerous hypotheses related to the issues from the Issue Tree, providing possible different answers to the issues.
3. Analysis Required: Analyses, rationale, and key data tools/techniques we could use to confirm or refute each hypothesis. Each hypothesis may have multiple analysis steps. For example: Estimate of first-time PC buyer market, a company's current market share among first-time buyers, values of those buyers vs. a company's value proposition, potential competitor strategies/reactions.
4. Data Sources: Research firms, industry analysts, internal client sources, primary research, etc., who will most likely provide the best data for the analyses.

The Workplan includes three major elements:
1. Workstream: The user takes a step back and read through all the various analyses and data sources required. The user groups the research and analyses into logical workstreams, making sure to combine analyses that rely on similar data or sources so that team members may avoid duplication.
2. Owner & Resources: The user identifies who will be responsible for completing each workstream, including a team lead and the members.
3. Timeframe: Estimate duration and due dates for each workstream.

The research plan's Issue Analysis Worksheet provides the link between the Issue Tree and the research and analysis. The Issue Analysis Worksheet builds on the Issue Tree, further specifying hypotheses that need to be tested to answer the key question and develop an appropriate solution.

Upon completion of the research plan, the user next selects the Quality Check option of the research plan drop-down menu 152 to ensure completeness and accuracy of the research plan. The research plan module 150 then walks the user through a series of questions addressing the completeness and accuracy of the research plan. For example, the research plan module 150 may present the user with the following series of questions:

Has the User Created an Accurate Issue Analysis Worksheet?
Are the hypotheses stated as facts that can be proved or disproved?
Are the “analyses required” sufficient to prove/disprove the hypotheses? Has the user taken into account any client biases, explicit or implicit, for or against certain kinds of analyses, data, or sources?
Are the data sources the best choices given the alternatives and limitations? Has the user considered data that could serve as a solid proxy for what the user needs, possibly saving time and money? Does the user require statistically valid proof and a broader test or is a smaller, less precise sample sufficient?
Has the user made explicit trade-offs between time, cost, and quality in identifying the data sources?

Has the user Created an Effective Workplan?
Does each workstream include a set of related items? Does the grouping seem reasonable and logical? Can the user give the workstream a simple name and can people understand what is included?
Is there any possible duplication of effort between the workstreams? For example, conducting interviews of the same person or group. If so, the user may want to rethink the groupings or note the overlap for coordination.
Are the timeframes appropriate given the amount of work? Does the user need to rethink the approach or the level of resources?
Are these timeframes and due dates consistent with client expectations or inputs needed for other related efforts?

At this point, according to generally known problem solving and management techniques, the issues and tasks in the research plan from the research plan module 150 may be researched by a findings generation module 160. The findings generation module 160 may contain logic to automatically perform the tasks contained the research plan module 150. For example, the findings generation module 160 may search the Internet or a more discrete research set. Alternatively, the various tasks contained research plan are performed and the outcomes are provided into the findings generation module 160 to storage and presentation to other team members.

The findings produced or contained in the findings generation module 160 can then be presented to the user by an idea generation module 170. The user can review these findings to generate ideas as needed to determine whether the issues identified by the idea structuring module 140 have been adequately addressed. The idea generation module 170 may include preprogrammed logic to access the sufficiency of the findings. Where the issues identified by the idea structuring module 140 have not been adequately addressed, the process continues with a reexamination of the issues and the creation of a new issue tree, perhaps with different topics or a different topic breakdown. Thus, the iterative problem solution process of module 130 continues until an adequate solution is found for the problem defined by the problem definition module 120 of FIG. 2.

Returning to FIG. 1, once a desirable solution is found by module 130, the problem solving tool bar 100 continues with a solutions communications module 180 the is used to present the proposed solution to the client. In a preferred implementation, the solutions communications module 180 contains several sub-modules that the user may access through a message plan button 181, a pyramid button 183, and a story board button 185.

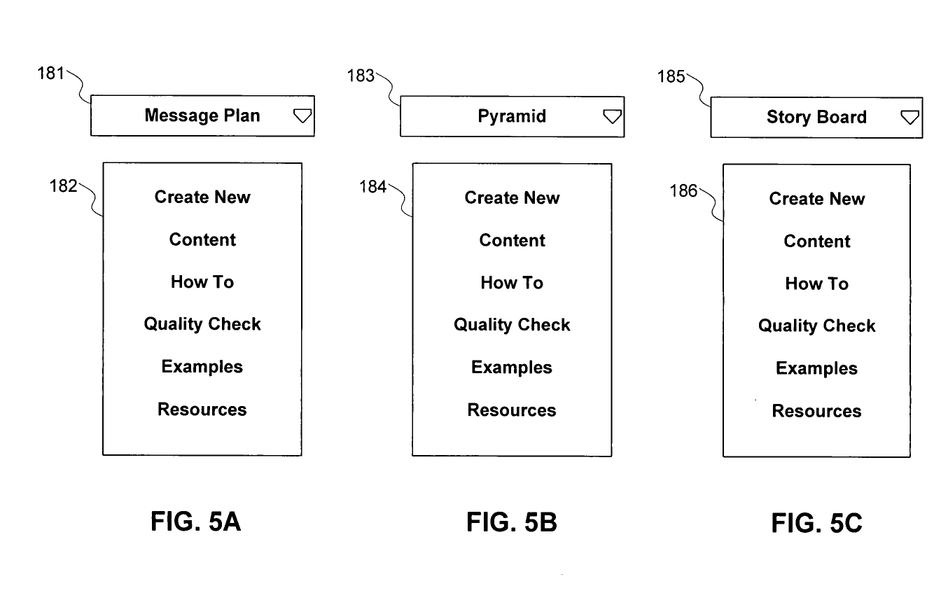

The message plan button 181 leads the user to a message plan menu 182 depicted in FIG. 5A. The user opts a create new option in the message plan menu 182 to begin the creation of a message plan to present the proposed solution. Message planning is the starting point for making sure that communications achieve defined objectives. Message planning focuses on what the listeners need or want to know, not on what the user wants to tell them. Message planning helps the user draw, and then communicate, audience-specific conclusions about data, rather than demonstrate how much the user learned in the course of researching the client's problem. Thus message planning shifts the question from “What am I going to say?” to “What does my client need to know?”

Message planning is useful because effective message planning creates the context for making decisions and answering questions (see below) about substance, strategy, structure, and style, thereby laying the foundation for better communication.

In creating the message plan, the user wants to say something to the listeners that will arouse their interest and motivate them to listen. Simply put, it's the benefits statement for the listeners. The message is different than a Main point, which is what the user wants the audience to do as a result of the message (for example, make a decision, be persuaded by the argument, articulate objections to the line of reasoning). The message performs two crucial functions in the planning process. First, the message moves the audience in the direction of Main point, in that the message attracts the audience's attention and motivates the audience to act. Secondly, the message helps the user to select the content of the communication (whether it is a talk, presentation, memo, conversation, etc.). The message raises questions in the minds of the listeners, and the answers to these questions will be the content of the communication.

To create a Message Plan, the user first seeks to identify the audience and situation. The objective of message planning is to take the listeners from where they currently are to where the user wants them to be. If the user is successful, the listeners will leave the presentation more motivated to reach a goal or perform a task. To accomplish this, the user should first understand the audience and situation. To do this, communication module 180, as activated to create a message plan through message plan menu 182 may guide the user through a series of questions before deciding on the contents of the message:
Who will receive the communication?
What does the audience expect to get from the communication?
What is the audience's capacity for change?
Who has decision-making authority?
What is the company culture and environment?
Is inductive or deductive reasoning applicable?
What is the degree of roadmapping required?
Is an executive summary desirable?

In creating the message plan, the user should think of communication as a journey of taking listeners from a starting point to the main point. The main point is where the users wants the listeners to be when finished, what the user wants the listeners to do as a result of the communication.

The user should recognize that not all listeners will be ready to make the same amount of change to reach the Main point. Some user may be closer to that point than others. Thus, the user should make a strategic decision about which listeners to focus. The main point may speak to the majority of the listeners, or to those who are furthest from the main point. The user's primary task and ultimate goal as a speaker or writer is to direct the audience chooses to the desired result.

In creating a message plan, the user should identify “Secondary goals.” A secondary goal is a tangential need to be fulfilled, much like the Main point. Everyone has secondary goal, and they are statements such as “I want my audience to like me,” “I want to gain credibility with my audience,” and other such universal desires. Unlike the main point, however, a secondary goal is not the primary or explicit goal of the communication. As such, the secondary goal should not drive the communication or divert content choices from those appropriate for Main point. The secondary goal can be:
Personal: usually ego-related; for example, the user may want to impress the audience or to otherwise display skill and knowledge in the field of the problem.
Business: usually a longer-term destination, but one aligned with the main point; for example, the user may want to win a client account or be retained for a future project.
   There's nothing inherently wrong with secondary goals; however, they can distract the user from focusing on the main point if user does not recognize and then manage the secondary goals. When focusing on a secondary goal, the user may end up providing unnecessary information rather than leading the audience toward the main goal. This will probably cause the audience's attention to stray.

When preparing the message plan, the user should evaluate the current reality (Facts, Assumptions, Questions). Whenever communication takes place, there is a gap between the sender and the receiver. This gap can cause the communication to be misunderstood. The user can effectively manage the gap by assessing the Current Reality of the audience. The process of Assessing Current Reality can be summed up in two questions: (1) Upon what assumptions about the listeners does reaching the Main point depend; and (2) Are these assumptions true?

The user can only move the audience to Main point if the underlying assumptions, including knowledge of audience attitudes, opinions, and values, are accurate. As a result, the user should verify all of the assumptions. The user should evaluate the audience's capacity for change by questioning how much change the user can expect the audience to make to reach Main point. The audience location on the “continuum” should be confirmed by asking how much the audience knows, believes, and agrees with.

Once the user assess where the listeners are on the Communications Continuum-whether they are unaware, aware, will understand, could believe, or are ready to act, the user should look once again at the Main point to make sure it's achievable. If the initial assumptions were not correct, the user should otherwise reconfirm or revise main point based on correct assumptions. Second, re-evaluate how much change it is reasonable to expect of the audience. If the assumptions were correct, the user can confirm the Main point and move forward with even greater confidence.

At this point, the communications solution module 180 prompts the user to create the message. The difference between the message and the main point is that the Main point is a statement of what the user wants, whereas the message is a statement of why the listeners should want the same thing. The message should be stated in such a way that it motivates the listener to undertake the journey to the Main point. For example, the message could be “this new tracking system will give increased flexibility and generate additional revenue per year” while the Main point is “to compel the client to agree to the new tracking system.”

To assist the user in creating a message that incorporates the main point, the solutions communications module 180 guide the user through several questions to ensure that the listener is motivated to listen to the message:
What is in it for the listener?
What benefit would the listen get from being at the Main point?
What questions do the listener have that the Main point answers?
What problem of the listener would be solved by reaching the main point?

Every good message will automatically raise questions in the listeners' minds. These are usually obvious ones, such as: What? Why? How? (For example, “How will a new system generate additional revenues per year?”) The answers to these questions will create the content of the communication, beginning with message, and continuing with a series of answers to questions raised by the message.

Once the message plan is created, the communications solution module 180 (as accessed through the message plan menu 182) guides the user through a Quality Check consisting of series of question, such as

A. Has the user Written a Good Message?

1. Does the user really have a message?
Telling the client “where you are” or “what research you have done” is not a message (“I want to bring you up to date on our research . . . ”).
Also, be sure not the state objectives or the Main point rather than the message. For example, the Main point might be: “The company will adopt a new computer system . . . ,” while the message would be: “System XYZ is an easy to install and cost-effective computer system . . . ”

2. Do the user have the correct number of messages?
The most effective presentations have only one main message.

3. Is the user delivering the message at the right time?
It's important to present the message at the beginning of the presentation. If the message comes at the end of the communication, it doesn't meet listener's needs; or the listener has to wait too long and may stop listening before receiving the message.

4. Is the message stated as a single, active, clear and concise sentence?

B. Has the user Written a Good Main point?

1. What is the Main point?
Does the Main point answer the question: “When I'm finished speaking, my listeners will . . . ”?

2. Is the subject of the Main point the listener, and not the speaker?
Making listener(s) the subject forces the user to visualize the listener doing or being at the Main point.

3. Is the Main point limited to a single active verb?
Many speakers find it challenging to limit their Main point to a single active verb—something that can be observed or measured. Consider the difference between these two Main point's: “They'll like my product” and “They'll buy my product.” A listener buying the product gives the user a much clearer measure of the success than them just liking it.

4. Does my Main point have one destination?
If the talk is a journey, the talk should only have one destination. One verb and one destination gives the clear focus needed for planning.

C. Has the user Managed Secondary goal's?
The first and most important step in managing Secondary goal's is to identify them.

After the user has created a message plan, the user next accesses the communications solution module 180 through a pyramid plan menu 184 reached through a pyramid button 183 to prepare a Pyramid. The Pyramid is both a thinking tool and a communications tool. It is a structure that shows a thought hierarchy based on a main message and the ideas that directly support it. Since thinking is a continuous process of grouping and summarizing, the ideas to be presented tend to naturally form a Pyramid if they fit together logically.

A Pyramid is useful on two levels. From the bottom up, the pyramid is the clearest, simplest, and most natural way of organizing thinking. Specifically, the mind automatically sorts detailed information (the bottom of the Pyramid) into more general groupings (the key line) in order to comprehend it. Therefore, presenting research data and facts, the user starts with the details and move up to the general unifying idea.

From the top down, a Pyramid is the most effective way to the conclusions and the easiest way for a reader to absorb them. The clearest communication sequence is always to give the summarizing idea giving the supporting ideas being summarized. It is easier for people to comprehend detailed information when they know where it is leading. As a result, the user should start with the “so what” point (the top of the Pyramid) and follow with the supporting data.

Three Basic Principles Apply to Building Pyramids are:

1. Ideas at any level in the Pyramid must be summaries of the ideas grouped below them.

2. Ideas in each grouping are the same kind of idea (they must logically fall into the same category).

3. Ideas in each grouping must be logically ordered, for example, by:
chronology (for example, step one, step two, step three)
structure (for example, West Coast, Midwest, East Coast)
importance (critical things to be fixed, important things to be fixed, nice to have things to be fixed)
priority

Once the pyramid is created, the communications solution module 180 (as accessed through the pyramid plan menu 184) guides the user through a Quality Check consisting of series of question, such as

Does the Top of Pyramid State a Main Message?
Does the message offer insights and draw conclusions, or is it simply a restatement of the findings?
Does the message add value to the data, provide perspective, and enhance the understanding of underlying issues?

Does the Information Flow Up and Down the Pyramid Correctly?
Is each box a higher abstraction of the boxes below it?
Does each succeeding level answer the questions raised by the preceding level?
Is each box sufficiently supported by the boxes below it?
Does each box answer only the one question raised by the box above it?

Does the Information Flow Across the Pyramid Correctly?
Are all boxes on the same horizontal level at the same level of abstraction?
Are there at least two, and no more than five, boxes supporting the box above them?
Are all boxes on the same horizontal level logically the same (all steps, all reasons, all benefits, all ways, etc.)? Or are they a grouping of like ideas?
Are all boxes logically ordered?
Is the Pyramid MECE (no gaps, no overlaps)?

After the user has created a message plan and pyramid, the user next accesses the communications solution module 180 through a storyboard plan button 185 and a resulting storyboard plan menu 186 to prepare a Storyboard. At this point, the user has defined the problem at hand, performed analysis, and determined what the message, content, and structure of the communication will be. The user now has the task of actually “telling the story.” Storyboarding is the process of designating how many pages will be needed to tell the story, and roughing out the taglines (topic sentences) for each of those pages. Thus, the Storyboard is the initial sequencing of the full set of pages that will constitute the communication. In completing the Storyboard, the user actually creates the pages of a Presentation or draft the paragraphs of a prose document. This involves “fine-tuning” topic sentences and choosing appropriate supporting content for each page or paragraph.

The user first accesses the storyboard plan menu 186 to currently build a storyboard and the presentation. The Storyboard is the full set of pages that will make up the communication or Presentation. The Storyboard establishes the links between the overall structure of the communication and each individual page. Whether the Storyboard results in a slideshow presentation or a word processing document, e.g., created using, respectively, PowerPoint® or a Word® by Microsoft, Corp., the thought process by which one moves from story line (Pyramid) to Storyboard remains the same. The communications solution module 180 guides the user through a process that involves answering the following questions:
1. How many pages are needed to tell the story, and how should those pages be ordered?
2. How will each page contribute to tell the story outlined in the Pyramid, and what will be the main message of each page?

The Number and order the pages is the first question to be addressed. The user cannot simply tell the listener about every item of research and thought since many may be irrelevant. The communications solution module 180 helps the user to resist this temptation by suggesting the following principles:
Only use as many pages as are necessary to tell the story outlined in the story line (Pyramid).
Make each page pull its weight, by having it convey one message only.
Only use as much detail and content as is necessary and relevant to support the message.
   These principles will help the user to determine the number of needed pages. The order in which to place these pages is determined by and flows naturally from the Pyramid story line.

In a preferred implementation, the communications solution module 180 first directs the user to first allocate about 1 to 3 pages to introductory material. The Situation, Complication, Question/Answer, as previously defined, provide the substantive basis for these pages. The introduction should introduce the main message of the communication through contextual, non-controversial material. It should acquaint the audience with what it needs to know to follow the story line and, ideally, should interest the audience in what is about to come. The introduction presents old or historical information, to be distinguished from the body of the Presentation, which presents new information.

The communications solution module 180 then prompts the user to next present a main message that answers the question raised in the introduction, as well as the highest level of support or the key line. The user generally needs only a couple pages for the main message, or the main message may otherwise be diluted.

The communications solution module 180 thirdly directs the user to think about the support for each point in the key line, point by point, in the order presented. Specifically, the user needs to support each key line point at the necessary level of detail before going to the next key line point. Key line support will account for the majority of the pages in the Presentation. When read together, these pages should make a reliable case for the conclusions or recommendations.

Once the user has decided the page length and ordering of the presentation, the solution module 180 next directs the user to draft a tagline, or topic sentence, for each page. The topic sentence should state the single most important point the reader or listener should take away from that page. It should convey one message only, and by doing so make a significant contribution to the overall story mapped out by the Pyramid. All the topic sentences, linked together, should tell a coherent story and support the “so what” of the Presentation, even without reference to the visual or textual support.

The communications solution module 180 may then direct the user through several step for creating the Presentation after the user has completed the Storyboard. Ideally, the Presentation should be divided into the same number of sections as there are key line points, with each point fully supported before proceeding to the next point or section. First, the communications solution module 180 directs the user to polish the topic sentences that were roughed-out in the Storyboard to make sure that each of the topic sentences conveys one clear message. The communications solution module 180 then directs the user to determine how to best support each topic sentence; i.e. how to best enhance understanding and acceptance of the main message of that page only. Specifically, the communications solution module 180 directs the user to provide evidence (text, chart, or visual) that is easy to read and to grasp. The user does not need not to present all the data collected on a given point but, instead, only presents the data that is relevant and necessary to support the message of that one page.

If needed for the presentation, the communications solution module 180 may further connect the user to some type of known graphical display application or spreadsheet to create a chart. The chart should highlight the quantitative relationship that is the message of the topic sentence. Four charts that may be typically use are (1) a pie or stacked column that illustrates the components or share of a single total; (2) a bar chart that compares items (such as information based on sales or growth) or shows correlation; (3) a line graph or column chart that compares time series or frequency; and (4) a dot chart, which shows correlation between different data sets. In preparing the message and chart, the user should ensure that the audience should not need to work too hard to comprehend the message. The message, not the data, should drive the choice of chart. Typically, the fewer messages per chart, the better. Moreover, the communications solution module 180 directs the user to prepare a concept visual (or illustrations) that quickly highlights non-quantitative relationships to register the message of the topic sentence.

In preparing the text of the storyboard, the user is directed by the communications solution module 180 to be careful when adding text, so that the text is short and simple. For example, the communications solution module 180 may suggests that the user limits text support to five bullets because text-heavy pages may make the audience work too hard. Ideally, a page that balances minimal text with complementary pictures is usually most memorable and effective.

Alternatively, the communications solution module 180 may direct the user through the Storyboard process to create of a prose document (i.e., text) to express the problem, findings, and proposed solution. In general, the same thought process and principles that apply to creating the above described Presentation pages also apply to creating prose pages (and vice versa), but instead of thinking of pages, the user is creating paragraphs or sections. Thus, the communications solution module 180 first directs the user to draft the introduction paragraph, incorporating the content of the Pyramid and following the tips related to introductions. The communications solution module 180 then directs the user to secondly state the main message, or “so what” of the intended communication followed by a summary of the key line. The communications solution module 180 thirdly directs the user to divide the document into the same number of sections as there are key line points. Each point should be a separate section, and the heading for each section should reflect the idea to be developed in that section. In this way, the heading serves as a signpost to preview the contents of the message to the readers.

Fourthly, the communications solution module 180 directs the user to provide, for each section or key line point, the necessary and relevant content to support the main thought of the section. The number of levels of supporting detail for each key line point dictates the number of paragraphs in a given section. In accordance with desirable writing the communications solution module 180 directs user to begin each paragraph with a topic sentence that clearly states the central thought of the paragraph and to draft the rest. The rest of the paragraph should relate to and support that central thought. In this way, each paragraph is equivalent to a page of a Storyboard or Presentation, the first sentence of the paragraph is the equivalent of the tagline, and the rest of the paragraph is the prose equivalent to the visual material that supports the tagline.

To the communications solution module 180 directs the user to Fifth, draft a conclusion, which should leave the reader in the mindset the user wants to establish. There are very few rules here. While the conclusion should draw closure to the communication, usually through a summary of the main message, it can also provide some additional perspective or food for thought.

After the draft communications is completed, the communications solution module 180 directs the user through a series of questions to evaluate the communications, such as:
Has the user included enough pages, but not too many pages, based on the amount of time available, the audience's preferences, and content necessary to support the message of my communication?
Does each page convey only one message?
Does that message contribute to, and is it consistent with, the overall logic of the storyline?
Does each tagline convey the one main message of the page? Is the tagline concise and clear? Is it in an active, rather than a passive, voice?
Do the taglines, read in order, tell a coherent story?
Do the charts and text on each page support the main message of that page as stated in the tagline?
Do the charts and text on each page properly support the quantitative, qualitative or conceptual data?
Does each page contain the right balance of pictures and words or are there too much text or pictures?
In preparing the pages, has the user considered the audience, namely their known preferences, their knowledge levels, etc.?

To further assist the user in the communicating the solution, the solution communications module 120 may provide definitions of the different portions of the message plans, pyramid, and story board through the Content option of, respectively, the message plan drop-down menu 182, the pyramid drop-down menu 184, and the story board drop-down menu 186. Similarly, the “how to” option of the message plan drop-down menu 182, the pyramid drop-down menu 184, and the story board drop-down menu 186 may provide instructions regarding completing the sections of the message plan, the pyramid, and the story board. The examples option of the message plan drop-down menu 182, the pyramid drop-down menu 184, and the story board drop-down menu 186 may further provide examples of completed sections of the of the message plan, the pyramid, and the story board in order to guide the user through the communications solution process.

### CONCLUSION

The foregoing description of the preferred embodiments of the invention has been presented for the purposes of illustration and description. It is not intended to be exhaustive or to limit the invention to the precise form disclosed. Many modifications and variations are possible in light of the above teaching. For instance, the method of the present invention may be modified as needed to incorporate new communication networks and protocols as they are developed. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A computer-readable storage medium containing a set of instructions for solving of a problem, the set of instructions implementing a process comprising:
defining the problem representing a situation having a current condition and a desired condition;
generating a solution the problem, the solution generating step comprising forming an issue tree to structure at least one issue related to the problem, developing a research plan, for generating findings related to the issue tree; and documenting the findings; and
creating a presentation for communicating the solution formed from the findings, wherein the step of creating a presentation for communicating the solution comprising creating a message plan summarizing the problem and the solution; creating a message pyramid organizing contents of the presentation; and using the message plan and the pyramid to form the presentation.

2. The computer-readable storage medium of claim 1, wherein the message pyramid comprises a hierarchical structure, wherein the pyramid comprises one or more pyramid levels of differing logical abstraction.

3. The computer-readable storage medium of claim 2, wherein each of the pyramid levels is Mutually Exclusive, Collectively Exhaustive.

4. The computer-readable storage medium of claim 1, wherein the communication is a storyboard visually displaying the solution.

5. The computer-readable storage medium of claim 1, wherein the communication is a prose document describing the solution through text.

6. The computer-readable storage medium of claim 1, wherein the step of defining a problem comprises the creation of a problem definition worksheet specifying the situation, identify a complication preventing the desired condition, and defining a key question to be addressed in solving the problem.

7. The computer-readable storage medium of claim 6, wherein the creation of a problem definition worksheet comprising acquiring a blank problem definition worksheet and directing the user in completing blank problem definition worksheet.

8. The computer-readable storage medium of claim 6, wherein the step of defining a problem further comprises presenting an exemplary problem definition worksheet.

9. The computer-readable storage medium of claim 1, wherein the issue tree breaks down the Key Question into one or more components, wherein the issue tree comprises one or more issue tree levels of differing logical abstraction, wherein the issue tree levels are Mutually Exclusive, Collectively Exhaustive.

10. The computer-readable storage medium of claim 1, wherein the research plan comprises an issue analysis worksheet and a work plan.

11. The computer-readable storage medium of claim 10, wherein the issue analysis worksheet comprises a restatement of the issue; a hypothesis proposing an answer to the issue; a required analysis estimation proposing one or more actions for testing the hypothesis; and a data source estimation proposing a data source for the proposed actions.

12. The computer-readable storage medium of claim 11, wherein the work plan comprises a workstream grouping one or more of the hypothesis testing actions, a roster designating one or more people to perform the workstream, and a schedule for carrying out the workstream by the roster.

13. The computer-readable storage medium of claim 1, wherein the issue tree is a first issue tree, the research plan is a first research plan, and the findings are first findings; and wherein the solution generating step comprising forming a second issue tree to structure a second issue produced from the first findings of the first issue tree, developing a second research plan for generating second findings related to the second issue tree; and documenting the second findings related to the second issue tree.

14. A problem solution tool comprising:
a problem definition module for guiding a user to define a problem through a problem definition worksheet;
a solution generation module for guiding the user in solving the problem, wherein the solution generation module guides the user to structure at least one issue related to the problem through an issue tree, wherein the solution generation module guides the user form a research plan for generating findings related to the issue tree, and wherein the solution generation module accepts input from the user to document the findings; and
a presentation module for visually displaying a solution formed from the findings, wherein the presentation module comprises a message plan creation module, a message pyramid creation module organizing contents of the presentation; and a storyboard creation module that uses the message plan and the pyramid to form the presentation.

15. The problem solution tool of claim 14, wherein the message pyramid comprises a hierarchical structure, wherein the pyramid comprises one or more pyramid levels of differing logical abstraction.

16. The problem solution tool of claim 15, wherein each of the pyramid levels is Mutually Exclusive, Collectively Exhaustive.

17. The problem solution tool of claim 14, wherein the problem definition module creates a problem definition worksheet specifying the situation, identify a complication preventing the desired condition, and defining a key question to be addressed in solving the problem.

18. The problem solution tool of claim 17, wherein the problem definition module acquires a blank problem definition worksheet and directs the user in completing blank problem definition worksheet.

19. The problem solution tool of claim 17, wherein the problem definition module presents an exemplary problem definition worksheet.

20. The problem solution tool of claim 14, wherein the issue tree breaks down the Key Question into one or more components, wherein the issue tree comprises one or more issue tree levels of differing logical abstraction, wherein the issue tree levels are Mutually Exclusive, Collectively Exhaustive.

21. The problem solution tool of claim 14, wherein the research plan comprises an issue analysis worksheet and a work plan.

22. The problem solution tool of claim 21, wherein the issue analysis worksheet comprises a restatement of the issue; a hypothesis proposing an answer to the issue; a required analysis estimation proposing one or more actions for testing the hypothesis; and a data source estimation proposing a data source for the proposed actions.

23. The problem solution tool of claim 22, wherein the work plan comprises a workstream grouping one or more of the hypothesis testing actions, a roster designating one or more people to perform the workstream, and a schedule for carrying out the workstream by the roster.

24. The computer-readable storage medium of claim 14, wherein the issue tree is a first issue tree, the research plan is a first research plan, and the findings are first findings; and wherein the solution generation module forms a second issue tree to structure a second issue produced from the first findings of the first issue tree, develops a second research plan for generating second findings related to the second issue tree; and documents the second findings related to the second issue tree.

25. A computerized method for addressing a problem comprising:
a computer defining the problem representing a situation having a current condition and a desired condition;
the computer generating a solution the problem, the solution generating step comprising forming an issue tree to structure at least one issue related to the problem, developing a research plan, for generating findings related to the issue tree; and documenting the findings; and
the computer creating a presentation for communicating the solution formed from the findings, wherein the step of creating a presentation for communicating the solution comprising creating a message plan summarizing the problem and the solution; creating a message pyramid organizing contents of the presentation; and using the message plan and the pyramid to form the presentation.

26. The computerized problem addressing method of claim 25, wherein the message pyramid comprises a hierarchical structure, wherein the pyramid comprises one or more pyramid levels of differing logical abstraction.

27. The computerized problem addressing method of claim 26, wherein each of the pyramid levels is Mutually Exclusive, Collectively Exhaustive.

28. The computerized problem addressing method of claim 25, wherein the communication is a storyboard visually displaying the solution.

29. The computerized problem addressing method of claim 25, wherein the communication is a prose document describing the solution through text.

30. The computerized problem addressing method of claim 25, wherein the step of the computer defining a problem comprises creating of a problem definition worksheet specifying the situation, identify a complication preventing the desired condition, and defining a key question to be addressed in solving the problem.

31. The computerized problem addressing method of claim 30, wherein the creation of a problem definition worksheet comprising the computer acquiring a blank problem definition worksheet, and the computer directing the user in completing blank problem definition worksheet.

32. The computerized problem addressing method of claim 30, wherein the step of defining a problem further comprises presenting an exemplary problem definition worksheet.

33. The computerized problem addressing method of claim 25, wherein the issue tree breaks down the Key Question into one or more components, wherein the issue tree comprises one or more issue tree levels of differing logical abstraction, wherein the issue tree levels are Mutually Exclusive, Collectively Exhaustive.

34. The computerized problem addressing method of claim 25, wherein the research plan comprises an issue analysis worksheet and a work plan.

35. The computerized problem addressing method of claim 34, wherein the issue analysis worksheet comprises: a restatement of the issue; a hypothesis proposing an answer to the issue; a required analysis estimation proposing one or more actions for testing the hypothesis; and a data source estimation proposing a data source for the proposed actions.

36. The computerized problem addressing method of claim 35, wherein the work plan comprises a workstream grouping one or more of the hypothesis testing actions, a roster designating one or more people to perform the workstream, and a schedule for carrying out the workstream by the roster.

37. The computerized problem addressing method of claim 25, wherein the issue tree is a first issue tree, the research plan is a first research plan, and the findings are first findings; and wherein the solution generating step comprising the computer forming a second issue tree to structure a second issue produced from the first findings of the first issue tree, the computer developing a second research plan for generating second findings related to the second issue tree; and the computer documenting the second findings related to the second issue tree.
